(19) United States
(12) Patent Application Publication
(10) Pub. No.: US 2014/0173495 A1
(43) Pub. Date: Jun. 19, 2014

(54) Bookmark Gesture Recognition

(71) Applicant: PERATECH LIMITED, (US)

(72) Inventors: Wook Chang, Seoul (KR); Sun Kyu Park, Seoul (KR)

(73) Assignee: PERATECH LIMITED, Brompton on Swale (GB)

(21) Appl. No.: 13/713,299

(22) Filed: Dec. 13, 2012

(51) Int. Cl. G06F 3/01; G06F 3/0483

(52) U.S. Cl. CPC G06F 3/017; G06F 3/0483
USPC 715/776

(57) ABSTRACT

Apparatus for displaying an electronic book comprising a touch screen and a processor. The touch screen displays a selected page of an electronic book, and has a touch input device configured to generate signals in response to a touch input. The processor comprises a touch acquisition module that generates touch position information, a gesture recognition module that determines if a touch input is a bookmark gesture in dependence of whether the touch position information is within a bookmark area, and a bookmark processing module that generates a bookmark for the selected page when a bookmark gesture is recognized by the gesture recognition module.

### BACKGROUND OF THE INVENTION

1. Field of the Invention

The invention relates to apparatus for displaying pages of an electronic book, such apparatus being known as e-book readers (also known as e-readers or e-book terminals) having a touch screen for receiving user inputs, and a method of receiving user inputs to a touch screen.

2. Description of the Related Art

In conventional e-book readers (also referred to as e-readers or e-book terminals), it is known to have a specific menu providing a bookmark button to allow a bookmark to be set up for the page that is currently selected. One problem with this is that the user must learn how to use the user interface, and know how to find the bookmark button. In addition, the user has to go through the process of opening the menu and pressing the bookmark button.

### BRIEF SUMMARY OF THE INVENTION

According to an aspect of the present invention, there is provided apparatus for displaying an electronic book comprising: a touch screen configured to display a selected page of textual information of an electronic book, said touch screen having a touch input device configured to generate signals in response to a touch input on said touch screen; and a processor comprising: a touch acquisition module configured to obtain touch position information of a touch input from said touch input device; a gesture recognition module configured to determine if a touch input is a bookmark gesture in dependence of whether said touch position information is within a bookmark area or not within said bookmark area; and a bookmark processing module configured to generate a bookmark for the selected page when a bookmark gesture is recognized by said gesture recognition module.

Therefore, as a consequence, the user is able to set up a bookmark and delete an existing bookmark in the e-book reader in a natural and instinctive manner, and similar to the way the user may add or remove a bookmark in a book.

Particularly, the user can naturally set up and release (or delete) a bookmark of the page by applying touch, drag, touch-hold, stroke gesture, and touch with constant pressure to a part of the page, for example a corner or an edge.

### BRIEF DESCRIPTION OF THE DRAWINGS

FIG. 1 shows a schematic diagram of an e-book reader 100 embodying the present invention;

FIG. 2A shows the touch input device 120 and the display unit 110 of the e-book reader 100 as arranged in an embodiment of the invention;

FIGS. 2B and 2C show an alternative arrangement of an e-book reader 100′ embodying the invention;

FIGS. 3A and 3B show the bookmark areas according to two embodiments of the present invention;

FIG. 4A shows a valid touch 401 generated by a user 402 on the touch screen 150;

FIGS. 4B and 4C show the user 402 generating drags (411 and 421) in the bookmark area;

FIG. 5 shows an example page 501 view of the e-book reader 100;

FIG. 6 shows the configuration of an e-book reader 600 for performing the bookmark set up method according to another embodiment of the presented invention;

FIGS. 7A to 7E show a user 750 providing touch inputs to the touch screen 650 of the e-book reader 600;

FIGS. 8A, 8B and 8C show a user 750 inputting first and second touches on the touch screen 650′ of the e-book reader 600′ in which the touch screen is configured to receive multiple simultaneous touches;

FIG. 9 shows a corner of the touch screen 650′ after a first touch has been received and the line 840 is displayed;

FIG. 10 shows a flow chart of a bookmark set-up method embodying the present invention;

FIG. 11 shows the multiple steps forming the recognition process of the bookmark gesture of step 1020 of FIG. 10; and

FIG. 12 shows the multiple steps forming the recognition process for the bookmark confirmation gesture at step 1040 of FIG. 10.

### DETAILED DESCRIPTION OF EXAMPLE EMBODIMENTS

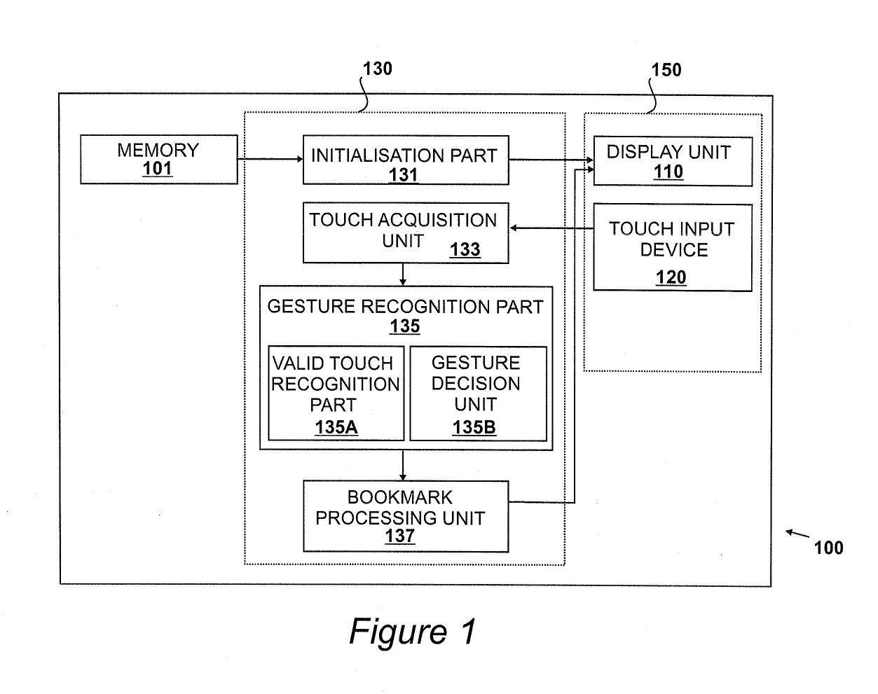

### FIG. 1

A schematic diagram of an e-book reader 100 embodying the present invention, and allowing bookmarks to be set up by a method according to the present invention, is shown in FIG. 1.

The e-book reader 100 comprises a computer readable medium, in the form of memory 101, a processor 130, and a touch screen 150 comprising a display unit 110, and a touch input device 120.

The memory (101) may be implemented as a storage media such as a hard disk, magnetic media such as a floppy disk or magnetic tape, a CD-ROM drive, optical recording media (optical media) like DVD, magneto-optical media such as a floptical disk, a ROM, a RAM, flash memory, etc.

The memory 101 stores reference data for the operation of a program (hereinafter called ‘e-book application’) run by the processor 130, for controlling and displaying the e-book contents. Particularly, the memory 101 stores e-book contents for the aforementioned e-book application and comprises a plurality of contents and bookmark configuration information for each page.

The display unit 110 provides multiple pages for data display. Contents requested by the e-book application for display are indicated on the screen, along with appropriate graphics.

In the present embodiment, the touch input device 120 of the touch screen 150 is of a conventional type, in which the electrical resistance changes with applied force (or pressure). In the present embodiment the touch input device is of a type including a quantum tunnelling composite material such as QTC (manufactured by Peratech Limited in the UK), but alternative embodiments include the use of an FSR (Force Sensing Resistor) material. Also, in an alternative embodiment the touch input device is of the type in which sensing circuitry senses electrical changes caused by deformation of the outer shape of the touch screen by applied force (or pressure).

In some embodiments of the present invention the touch input device 120 is of a known type configured to receive single touches while other embodiments use known types of touch input device configured to receive multiple simultaneous touches. In each case, the touch applied to the touch input device by a hand or pen of a user is converted into electrical signals that are supplied to the processor 130.

Under the instructions of the e-book application and according to requests of a user, the processor 130 manages the e-book contents saved in memory 101 and displays e-book content on the display unit 110.

The processor 130 comprises an initialization part 131, the touch acquisition unit 133, and the bookmark gesture recognition part 135 and bookmark processing unit 137.

The bookmark gesture recognition part (135), itself, includes a valid touch recognition part (135A) and a gesture decision unit (135B).

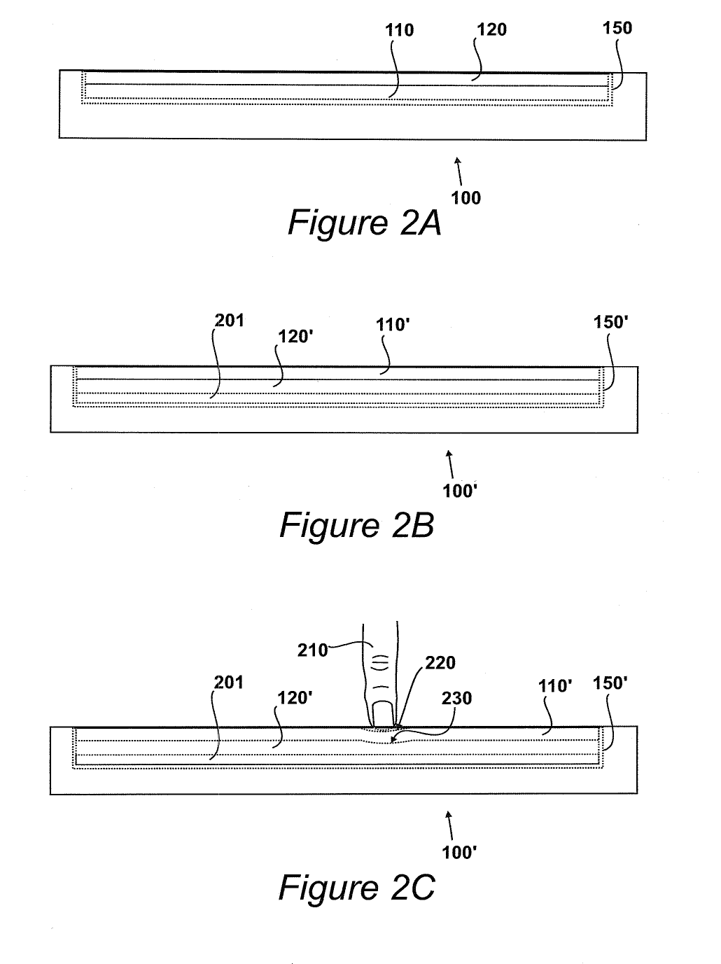

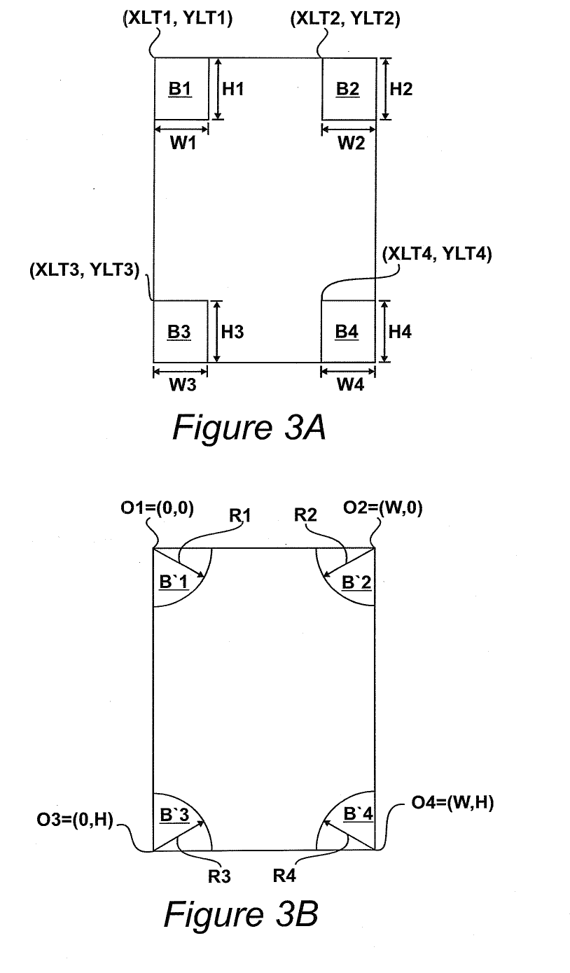

### FIGS. 2A, 2B and 2C

The touch input device 120 and the display unit 110 of the e-book reader 100 are arranged in the an embodiment of the invention as shown in the FIG. 2A, while an alternative arrangement of an e-book reader 100′ providing an alternative embodiment is shown in FIGS. 2B and 2C. It should be understood that the e-book readers 100 and 100′ are similar except for the arrangement of their touch input devices and display units.

The touch input device 120 is shown in FIG. 2A installed on the top of the display unit 110, and the touch input device 120 directly senses the touch by the hand or the pen of a user. In an embodiment, this is implemented as a conventional touch screen, and the touch input device 120 comprises of a transparent material so that the user looks at the screen of the display unit 110.

A touch input device 120′, having an alternative arrangement to that to FIG. 2A, is shown in FIG. 2B and also in FIG. 2C under the force of a finger 210 of a user. In this arrangement, the display unit 110′ is arranged above the touch input device 120′ and a supporting plate 201 is located beneath the touch input device 120′. The touch input device 230 is able to sense a finger 210 of a user, as shown in the FIG. 2C, through the display unit 110′. In other words, if the user touches the display unit 110′ using their finger 210, the pressure or force of the touch causes deformation 220 of the display unit 110′, and the deformation of the display unit 110′ induces deformation 230 of the touch input device 120′ located below the display unit 110′. In this manner, the touch input device 120′ is able to recognize the touch of a user.

The supporting plate 201 locates against the lower part of the touch input device 120′ in order to allow the touch input device 120′ to recognize touches on top of the display unit 110′, while preventing touches to the lower surface, which would otherwise result in false detection of a user's touch.

In the arrangement of FIGS. 2B and 2C, the touch input device 120′ does not cover the display unit 110′ and so good visibility of the display unit is assured.

A selected page that is of interest to the user, which is selected as the user manipulates the e-book reader, is received by the initialization part 131, and displayed by the display unit 110. At least one corner or at least one edge portion of the touch screen 150, which displays the selected page, is defined as the bookmark area, and this is used by the valid touch recognition part 135A of the described bookmark gesture recognition part 135 as will be described below.

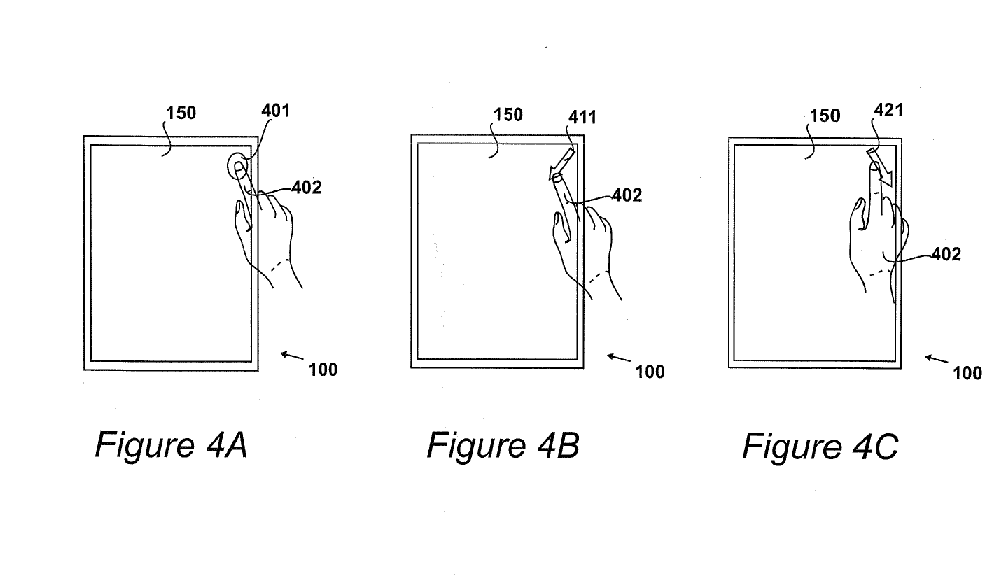

### FIGS. 3A and 3B

The bookmark areas according to two embodiments of the present invention, are shown in FIG. 3A or 3B. The initialization part 131 defines the areas of the touch screen that are to be used as bookmark areas. In the embodiment of FIG. 3A there are four defined rectangular areas B1, B2; B3, B4, each in a respective corner of the screen, which form the bookmark area. In such a case, where the bookmark areas are rectangular, the initialization part 131 defines the location (XLTi,YLTi, i=1, 2, 3, 4) of the rectangle, and the width (Wi) and height (Hi) of each rectangle.

In the embodiment of FIG. 3B, the initialization part 131 defines four quadrant shaped areas, B′1, B′2, B′3, B′4, one in each of the four corners of the screen, as bookmark areas. To define the quadrant bookmark areas, the initialization part 131 defines the centre point location (Oi=(OXi, OYi)) of the quadrant, and the radius (Ri) of the quadrant.

It should be understood that the bookmark area may comprises several areas, as in FIGS. 3A and 3B, allowing a user to create a bookmark by using one of the several areas. However, in an embodiment of the invention, the bookmark area comprises only one such area, for example in a top corner of the touch screen.

In an alternative embodiment (not shown), the initialization part 131 defines the bookmark area as an edge portion of the touch screen having a fixed width on the displayed page. That is, the bookmark area is oblong and extends along an edge of the screen, such as the upper edge or a side edge. In addition, in an embodiment, the initialization part 131 defines the aforementioned bookmark area as an area which is shown on the display as folded sheet (of paper) to represent the aforementioned bookmark (as will be described below).

The touch acquisition unit 133 is configured to get the location information of an acknowledged touch through the touch input device 120 from a user, and provide the location information to the bookmark gesture recognition part 135. In other words, the touch acquisition unit 133, having touch recognition software, acquires touch position information corresponding to the touch received by the touch input device 120 and then transfers the position information to the bookmark gesture recognition part 135.

The bookmark gesture recognition part 135 is configured to recognise a user's gesture as a bookmarking gesture if the touch position information corresponds to a touch position, or touch positions, included in the bookmark area. In other words, the bookmark gesture recognition part 135 determines whether the touch position information is included in the bookmark area and, if the bookmark gesture recognition part 135 confirms that the touch position information is included in the bookmark area, then the bookmark gesture recognition part 135 recognizes the touch as a valid touch and then determines whether the position information of the touch or touches relate to a predefined bookmark gesture.

If the bookmark gesture recognition part 135 determines that touch position information corresponds to a touch position that is not in the bookmark area, then it decides that the received gesture is not a bookmark gesture.

The valid touch recognition part 135A is configured to decide whether touch position information, generated during a touch by the user, corresponds to valid touch positions, based on whether the location of the touch is within the bookmark area.

In the particular case in which the initialization part 131 defines the bookmark area as a rectangle in four corners of the screen, the valid touch recognition part 135A determines whether the location of a touch is included in the ith bookmark area (Bi) through a condition, such a that given in the following conditional statement, Conditional Statement 1. In this way it determines if the touch is valid.

Conditional Statement 1
IF (XLTi<XT) AND (XT<XLTi+Wi) AND (YLTi<YT) AND (YLTi<YT+Hi)
   THEN PT belongs to Bi (i.e. the location of the touch is in the bookmark area),
   OTHERWISE PT does not belong to Bi (i.e. the location of the touch is not in the bookmark area).

Alternatively, in the case in which the initialization part 131 defines the bookmark area as the quadrant in four corners of the screen, the valid touch recognition part 135A determines whether, or not, the location (PT=(XT, YT)) of touch belongs to the bookmark area (Bi) through a condition like the following (Conditional Statement 2), and the valid touch recognition part 135A determines whether the touch is a valid touch.

### Conditional Statement 2

IF (XT−OXi)*(XT−OXi)+(YT−OYi)*(YT−OYi)<Ri*Ri
   THEN PT belongs to Bi (i.e. the location of the touch is in the bookmark area)
   OTHERWISE PT does not belong to Bi (i.e. the location of the touch is not in the bookmark area).

Alternatively Conditional Statement 2 may be expressed as:

### Conditional Statement 2

IF SQRT{(XT−OXi)*(XT−OXi)+(YT−OYi)*(YT−OYi)}<Ri
   THEN PT belongs to Bi (i.e. the location of the touch is in the bookmark area)
   OTHERWISE PT does not belong to Bi (i.e. the location of the touch is not in the bookmark area).

Similarly, in alternative embodiments in which the initialization part 131 defines the edge area or a folding area as the bookmark area, the valid touch recognition part 135A determines if the touch is valid by using the conditions for the edge area or folding area respectively.

When the valid touch recognition part 135A determines that a touch is a valid touch, the gesture decision unit 135B is configured to determine whether a bookmark gesture has occurred, in dependence upon whether one or more parameters of the received valid touch or touches has exceeded a respective threshold.

When the valid touch recognition part 135A determines that a touch is a valid touch, the gesture decision unit 135B decides whether a bookmark gesture has occurred in dependence upon at least one of several factors, the factors being: a number of valid touches whose number of occurrences exceeds a predefined threshold number; touch hold time that is longer than a predefined threshold period; and a drag (touch) whose length across the touch screen is longer than a predefined threshold length. If the gesture decision unit 135B determines that a bookmark gestured has occurred, the gesture decision unit 135B displays appropriate graphics, such as a graphic showing that the page is folded and this graphic is synchronized with the occurrence of the bookmark gesture. Thus, the generation of this graphic and the user's bookmark gesture appear to the user to occur simultaneously, thereby giving the user a similar experience to that of creating a real bookmark.

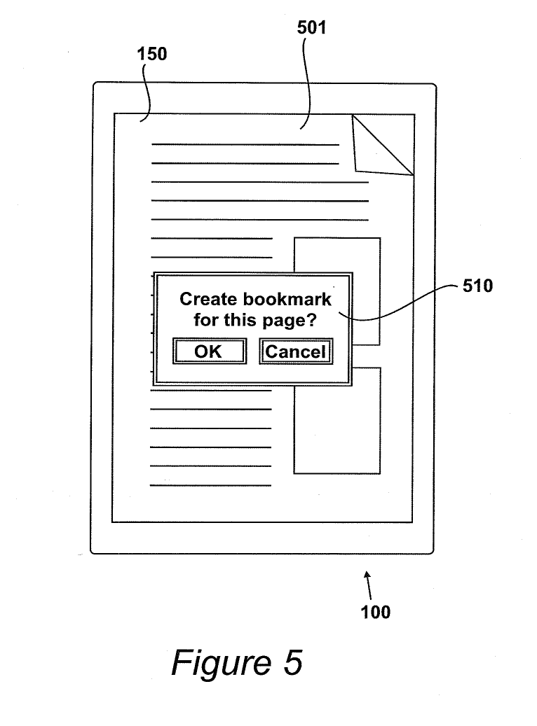

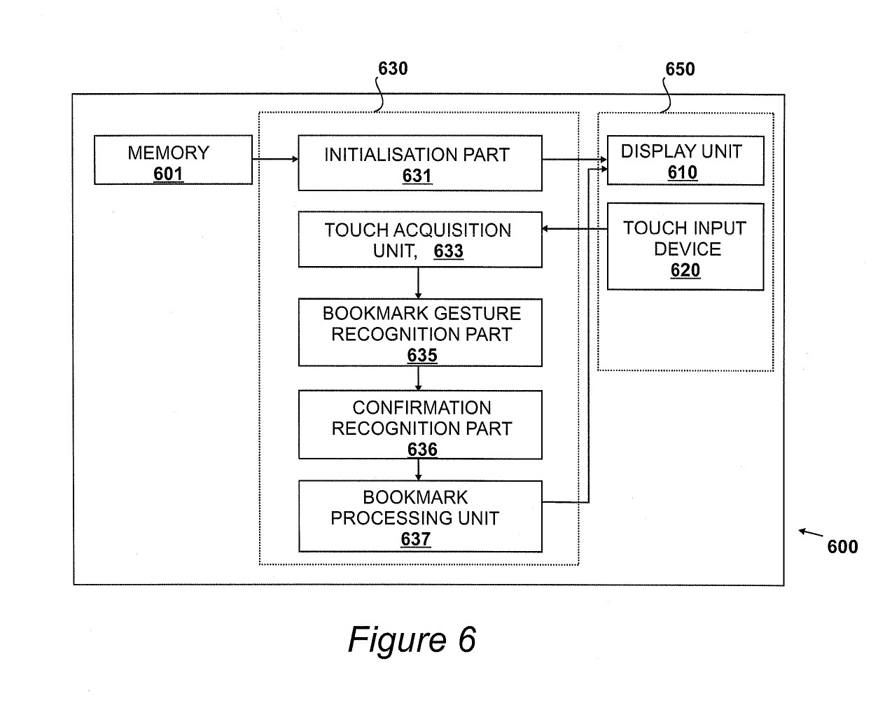

Here, the bookmark gesture is the specific gesture in which the user touches the screen of the e-book reader in order to request the establishment of the bookmark. An example of this will be explained with reference to FIGS. 4A, 4B and 4C.

### FIGS. 4A, 4B and 4C

A valid touch 401 generated by a user 402 on the touch screen 150 is shown in FIG. 4A, while in FIGS. 4B and 4C the user 402 is shown generating drags (411 and 421 respectively) in the bookmark area, over a length that is longer than the predefined length.

The gesture decision unit 1358 determines whether the touch or the drag created in FIG. 4A, 4B or 4C is a bookmark gesture depending on one of several factors. It can decide depending upon whether the touch hold is more than the predefined threshold period (i.e. a predefined length of time), whether the valid touch is a drag over the screen that is longer than a threshold length, and/or whether a reference count that the bookmark gesture generated is greater than a predefined number. More precisely, reference count is the count made by the software for one continuous touch, and touch is generally composed of several touch points. By using the reference count, it is possible to cope with the case when part of a touch, i.e., some touch points of a single touch, do not belong to the bookmark area.

In the case of FIG. 4A, the gesture decision unit 135B determines whether the valid touch is held more than the threshold period, i.e. a predefined length of time (e.g. 2 seconds), and whether the valid touch reference count that the bookmark gesture generated is greater than a predefined number (e.g. greater than one time). If it is found to be the case, then the gesture decision unit 135B recognizes the touch as a bookmark gesture, otherwise the touch is not recognised as a bookmark gesture.

In the case of FIGS. 4B and 4C, the gesture decision unit 135B decides whether the valid touch is a drag over the screen is longer than the predefined threshold length. In cases where the gesture decision unit 135B determines that the drag is longer than the threshold length, then the gesture decision unit 135B recognizes the touch as a bookmark gesture, otherwise the touch is not recognised as a bookmark gesture.

In the present embodiment, the gesture decision unit 135B recognizes a bookmark gesture through an algorithm like the following (Conditional Statement 3).

### Conditional Statement 3

IF PT belongs to Bi(i=1, 2, 3, 4)
   THEN set the output of the gesture decision unit 135B as GESTURE_BOOKMARKING

The above conditional statement is activated after the user's touch is finished. Here, PT={PT(1), PT(2), . . . , PT(N)} is the set of touch points which belongs to the user's touch.

GESTURE_BOOKMARKING flag means that the gesture decision unit 135B recognizes the user's touch as a bookmarking gesture.

Moreover, for the drag, in which the user moves the object (hand or the pen) contacted with the touch input device 120 in order to generate touch input, the location information of touch and the location information of the previous touch are compared by the gesture decision unit 135B to determine whether a bookmark gesture has been inputted.

In other words, in cases where the gesture decision unit 135B detects that the distance of the position-to-position of the location of a touch and a previous touch is greater than the preset threshold, it determines the drag as the bookmark gesture. This process can be implemented through the following conditional statement (Conditional Statement 4).

### Conditional Statement 4

IF SQRT((XT(n)−XT(n−1))*(XT(n)−XT(n−1))+(YT(n)−YT(n−1))*(YT(n)−YT(n−1)))>TH_D
   THEN TOUCH_DRAG is generated.

In Conditional Statement 4, the location information of the present touch is the PT (n)=(XT(n), YT(n)), and the location information of the previous touch is PT (n−1)=(XT(n−1), YT(n−1)). In cases where length of the drag is larger than the threshold length (TH D), the drag of the bookmark gesture is identified and it is acknowledged. Here, SQRT means the square root function.

In cases where the bookmark gesture is identified by the bookmark gesture recognition part 135B, bookmark gesture recognition part 135B indicates to the bookmark processing unit 137 that a bookmark gesture is detected, and, in response, the bookmark processing unit 137 establishes a bookmark for the page currently displayed.

Moreover, as the bookmark gesture is acknowledged the bookmark processing unit 137 automatically sets up a bookmark for the current page or alternatively it displays a separate confirmation window (as illustrated in the drawing 5) and the selection of the user can be input to the bookmark processing unit 137 to confirm that the current page should be bookmarked or should not be.

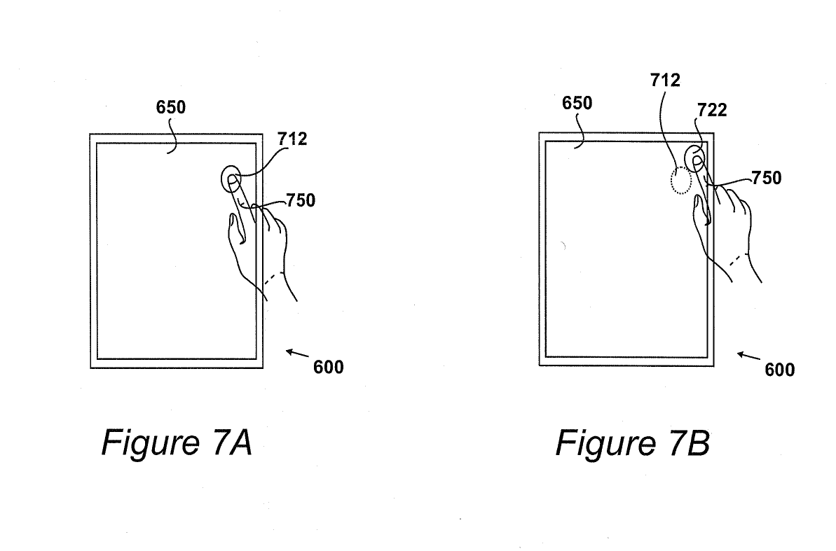

### FIG. 5

An example page 501 view of the e-book reader 100 illustrated in FIG. 1 is shown in FIG. 5. In the present embodiment, when the receipt of a bookmark gesture is indicated to the bookmark processing unit 137, it causes a confirmation window 510 to be popped up on the screen 150 in which the current page 501 is displayed. This provides an acknowledgement to the user that a bookmark gesture has been received (for example, by the valid touch more than the reference count, or by the drag more than the threshold length, or by a touch hold more than the threshold period. Accordingly, the user is able to provide a further input indicating that the bookmark should be set, or not, for the currently displayed page, for example by touching the “OK” button presented in the confirmation window 510.

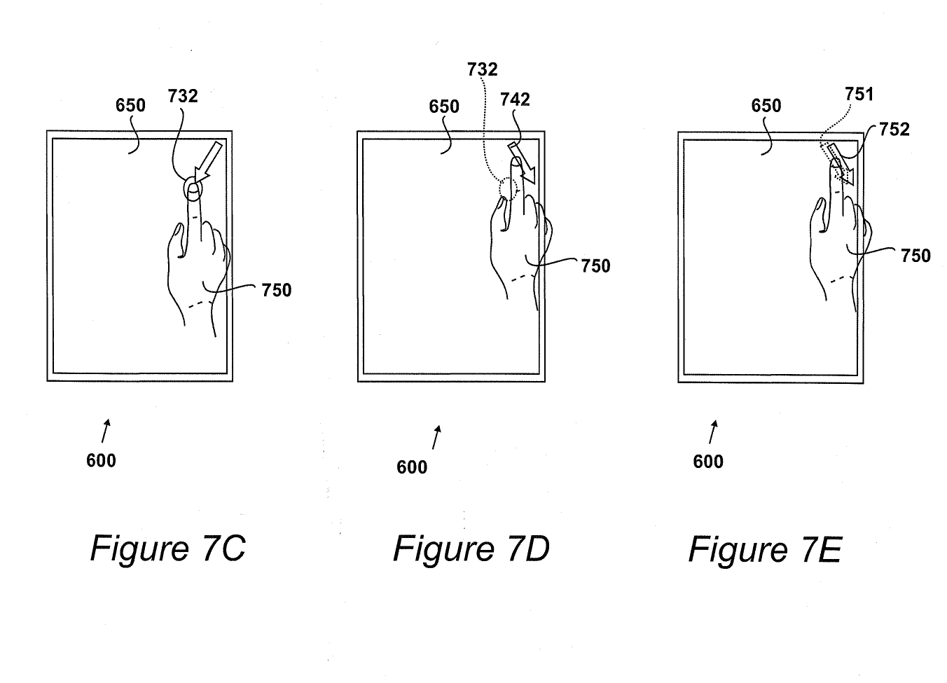

### FIG. 6

FIG. 6 shows the configuration of an e-book reader 600 for performing the bookmark set up method according to another embodiment of the presented invention.

In the case of the FIG. 6, the e-book reader 600 is arranged to recognize a bookmark confirmation gesture which indicates a user's confirmation for bookmarking, so as to set up the bookmark in the page of interest. Thus, in use, the e-book reader 600 recognizes the bookmark gesture in the same manner as the e-book reader 100 of FIG. 5 and then additionally recognizes a bookmark confirmation gesture which indicates a user's confirmation for bookmarking, so as to set up the bookmark in the page of interest.

The e-book reader 600 of the FIG. 6 comprises a processor 630, and other components (including a memory 601, and a touch screen 650 comprising a display unit 610 and a touch input device 620) which can be implemented identically with the configuration of the corresponding reference numerals 100, 150, 110, 120 respectively of the e-book reader of FIG. 1.

The processor 630 comprises an initialization part 631, a touch acquisition unit 633, a bookmark gesture recognition part 635, a confirmation recognition part 636, and a bookmark processing unit 637. Particularly, the initialization part 631, the touch acquisition unit 633, and the bookmark gesture recognition part 635 can be implemented identically with the configuration of the corresponding reference numerals 131, 133, 135 of the e-book terminal of FIG. 1.

The confirmation recognition part (636) is arranged to recognize a bookmark confirmation gesture of the user based on the location information of a touch. When the confirmation recognition part (636) indicates that a bookmark confirmation gesture has been identified, the bookmark processing unit (637) sets up a bookmark for the current page of interest.

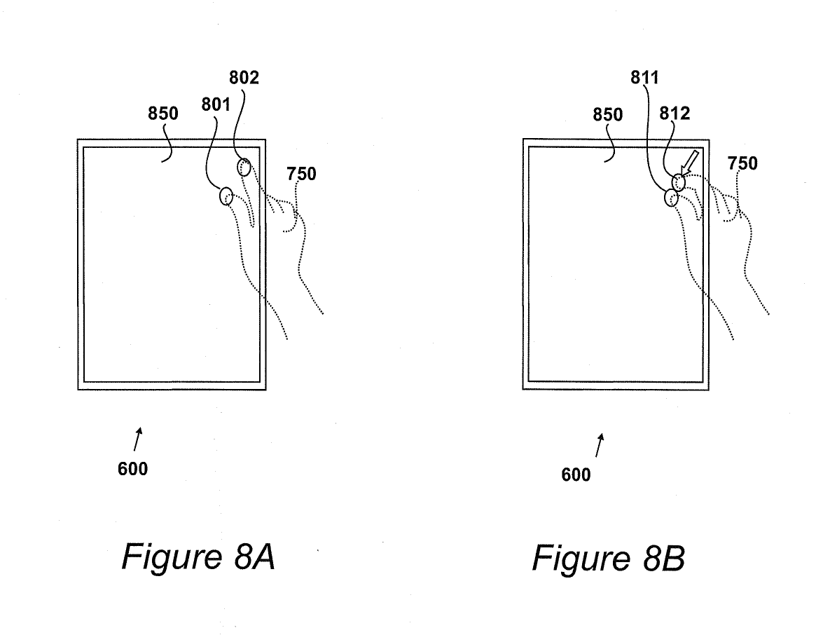

Here, the bookmark confirmation gesture is the specific gesture in which the user touches the screen of the e-book reader in order to confirm the establishment of the bookmark, and this will be explained through the examples illustrated in FIGS. 7A, 7B, 7C, 7D and 7E.

### FIGS. 7A to 7E

FIGS. 7A to 7E show a user 750 providing touch inputs to the touch screen 650 of the e-book reader 600.

A first example of bookmark creation is illustrated by FIGS. 7A and 7B. Firstly as shown in FIG. 7A, the user 750 the user generates a first valid touch by touching the screen at position 712 within the bookmark area for a period of time that is greater than a first threshold period. Thus the user indicates that a bookmark is required and the bookmark gesture recognition part 635 determines that a bookmark gesture is received. Having established a first valid touch 712, the user then provides a second valid touch 722 within the bookmark area, as shown in FIG. 7B, to confirm that a bookmark should be created for the currently displayed page. The second valid touch in the present example is a touch and hold for more than a second threshold period, and the confirmation recognition part 636 therefore determines that the bookmark confirmation gesture is received. In an alternative embodiment, the second valid touch itself comprises of two or more touches (or taps) each of which has a number of touch points that is greater than a threshold count.

A second example of bookmark creation is illustrated by FIGS. 7C and 7D. The user is shown in FIG. 7C generating a first valid touch 732 by dragging. Here, a first valid touch within the bookmark area is generated by a drag across the screen over a distance that is greater than a first preset length. In FIG. 7C the drag is performed by stroking the screen from the corner diagonally inwards towards the centre of the screen. Thus the motion performed by the user is similar to that of a person folding down a corner of a page of a real (paper) book to create a bookmark. The user then confirms that the bookmark should be generated by providing a second valid touch 742 as shown in FIG. 7D by making another drag within the bookmark area across the screen over a distance that is greater than a second preset length. In this example, the second drag 742 is across the angle of the corner, and therefore the motion performed by the user is similar to that of a person creasing the folded down corner of the page of a real (paper) book.

As will be described further below, having received a bookmark gesture, in some embodiments of the present invention the e-book 600 is configured to display a line across the corner of the displayed page, as if the page had a folded corner. The displayed line acknowledges the receipt of the bookmark gesture and prompts the user to provide the confirmation gesture of FIG. 7D by stroking along the line.

It should be understood that alternative embodiments are envisaged in which valid touches are generated other than by those described in FIGS. 7A and 7B, or 7C and 7D. Also, it should be noted that in alternative embodiments the e-book reader is configured to receive other combinations of static touches (like those of FIGS. 7A and 7B) and drags (such as those of FIGS. 7C and 7D). For example, a first valid touch may be made as shown in FIG. 7C and then the bookmark confirmed by a second valid touch of the type shown in FIG. 7A.

FIG. 7E illustrates a further example of generating a bookmark. Here, a first valid touch 751 is generated by dragging across the corner of the screen over a distance that is greater than a preset length, in order to indicate that a bookmark is required, and a second valid touch 752 is received providing a bookmark confirmation gesture by performing a second drag, substantially similar to the first drag, to confirm that the bookmark is required. Again, the bookmark confirmation gesture is prompted by the e-book reader in some embodiments by displaying a line across the corner of the displayed page.

The confirmation recognition part 636 is configured to determine whether the second touch or the drag is a bookmark confirmation gesture depending on one of several factors. In alternative embodiments, it decides depending upon whether the second touch hold 722 is more than a predefined threshold confirmation period (i.e. a predefined length of time), whether the valid touch is a drag 742, 752 over the screen that is longer than a threshold confirmation length, and/or whether a reference count that the confirmation gesture generated is greater than a predefined number.

Therefore, the confirmation recognition part 636 can sense the touch hold 722 more than the threshold period in the case of FIG. 7B, or alternatively the valid touch 722 more than the reference count can be sensed. Drags 732, 742, 752 of greater than a threshold length are sensed in the case of FIGS. 7D and 7E.

In a preferred embodiment, the e-book comprises a pressure acquisition unit (not illustrated). The processor 630 obtains the pressure information from a first touch and/or a second touch. In this case, depending on whether the pressure information obtained through the pressure acquisition unit is equal to, or greater than, a threshold pressure value or not, the confirmation recognition part 636 determines whether or not a bookmark confirmation gesture is generated.

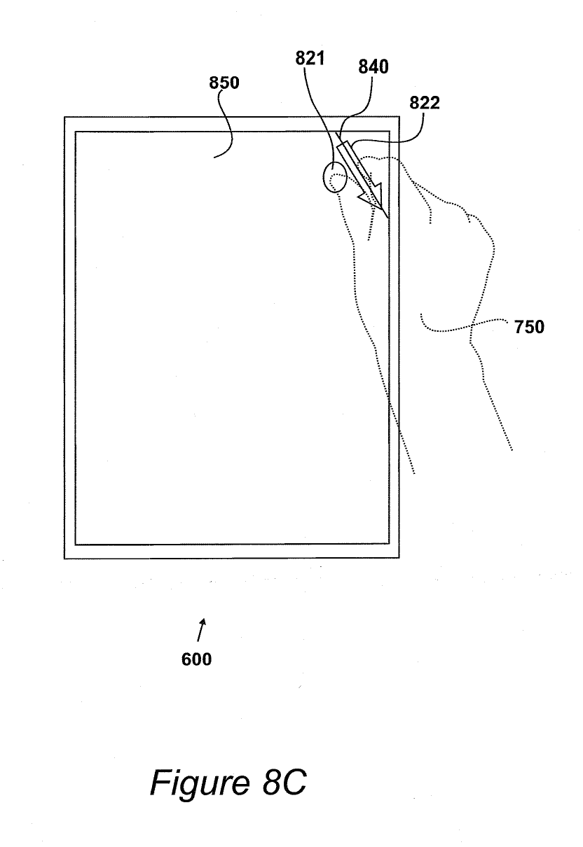

In the examples of FIGS. 7A to 7E, the operation of the confirmation recognition part 636 related to the case in which the touch input device 620 is embodied as a touch pad configured to receive single touches. But in alternative embodiments, an e-book reader 600′ is configured in a similar manner to e-book reader 600, but it has a touch screen 650′ comprising a multi-touch pad recognizing the multiple simultaneous touches, and the operation of the confirmation recognition part 636 in this case is explained through the FIGS. 8A through 8C.

### FIGS. 8A, 8B, 8C

A user 750 is shown in FIGS. 8A, 8B and 8C inputting first and second touches on the touch screen 650′ of the e-book reader 600′ in which the touch screen is configured to receive multiple simultaneous touches. In FIG. 8A the user generates a first touch 801 and a second touch 802 on the touch screen 650′ by touching and holding the touches for more than a preset period of time. Alternatively, as shown in FIGS. 8B and 8C, the e-book reader is configured to receive first touches 811, 821 on the screen 650′, while simultaneously receiving second touches 812, 822 in the form of a drag.

That is, the confirmation recognition part 636 can recognize whether the touch of the user is the bookmark confirmation gesture, or not, based on the location information of first touches 801, 811, 821 and simultaneous second touches 802, 812, 822.

In some embodiments, such as that of FIG. 8C, the confirmation recognition part 636 recognises that a bookmark confirmation gesture has been generated if the location information of the second touches 822 is included within a folding area. In this case, on receipt of the first touch, the screen displays a line 840 across the corner of the page, as if the page were a paper page with a folded corner. The line 840 illustrates to the user the location of a folding area and the user performs the second touch, confirming that a bookmark should be generated, by stroking across the screen along the line (hereinafter called ‘a stroke gesture’).

It will be understood that in a similar manner a line such as line 840 may also be presented to the user of a single-touch touch screen, such as touch screen 650 in FIG. 6, after receiving a bookmark gesture, to prompt the user to provide a bookmark confirmation gesture by stroking along the line.

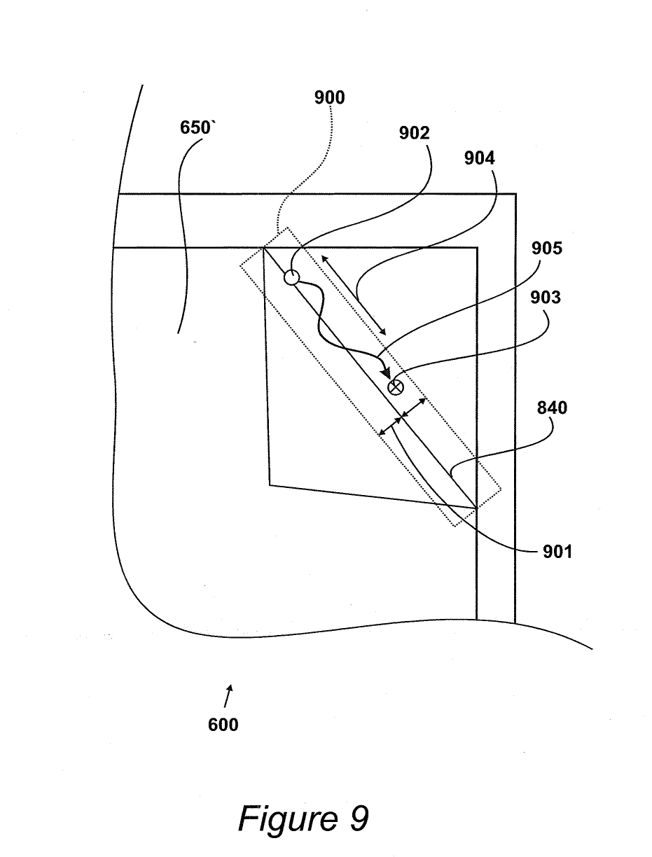

### FIG. 9

A corner of the touch screen 650′ is shown in FIG. 9 after a first touch has been received and the line 840 is displayed. A folding area 900 is indicated in dotted ‘outline in FIG. 9, but in the present embodiment it is not actually displayed on the touch screen. However in an alternative embodiment the folding area is displayed on the screen 650’.

The line 840 indicates to the user where the stroke gesture should be made in order to input the second touch and confirm that the displayed page should be bookmarked. However, if the user had to accurately stroke along the line this could prove impossible. Consequently, the e-book reader defines a folding area 900 that extends along the line 840 so that a part of the folding area extends by at least a minimum distance 901 to each side of the line. Consequently, the line 840 indicates to the user where the folding area is, and therefore where the stroke gesture should be made, but the finite width of the folding area allows for some inaccuracy by the user.

For the confirmation recognition part 636 to recognise a stroke as a second valid touch confirming the generation of a bookmark, it requires that the stroke start within the folding area, finish within the folding area and have a length that is greater than a preset threshold length. For example, in FIG. 9 a user strokes the screen in the folding area at an initial point 902 along a path 905 to a final point 903, and if the length of the stroke is greater than the preset threshold length 904, the confirmation recognition part 636 recognises the stroke as a bookmark confirmation gesture confirming that a bookmark is required.

It should be noted that one corner is shown in FIG. 9 to illustrate this confirmation process, but in some embodiments, the touch screen has a bookmark area in more than one corner, such as in all four corners. In such cases, when a bookmark gesture is detected by the bookmark gesture recognition part 635, a line such as line 840 is displayed in the corresponding corner and the confirmation recognition part 636 is then configured to detect whether a bookmark confirmation gesture is received in the form of a stroke along the line.

The folding line 840 of the bookmark can be expressed mathematically as ax+by+c=0. Here, a, b, and c are parameters determined according to the form of the bookmark.

It will be understood that the processor 630 (or processor 130) periodically samples the touch position information generated by the touch screen, and consequently, for one touch of the screen, such as a stroke, the processor identifies a contiguous series of information of touch points included in the stroke. Thus, for one stroke, if the location of the k numbered touch points (i.e the information of the k^{th} touch point of the stroke) is PT(k)=(xk, yk), then the distance d(k) between the folding line (840) and the k number touch location (PT(k)) can be calculated with the following equation (Equation 1).

$$d ( k ) = \frac{\vert a \times xk + b \times yk + c \vert}{\sqrt{{a}^{2} + {b}^{2}}} \qquad Equation 1$$

In addition, the length of the path of the stroke may be expressed in the following equation (Equation 2) from the first to the Nth point of the path. i.e. from k=0 to k=N, where PT(k) is the second touch location at the k number moment. In the Equation 2, the distance between two points “a” and “b” is denoted by d(a, b).

LPT=d(PT(1),PT(0))+d(PT(2),PT(1))+ . . . +d(PT(N),PT(N−1)) Equation 2

The stroke gesture recognition method as described above may be used by the bookmark gesture recognition part 135 or 635 in a process of recognising the bookmark gesture or the confirmation recognition part 636 in a process of recognising the bookmark confirmation gesture. Moreover, in cases where the touch input device 620 is implemented as the multi-touch pad it can recognize whether the stroke gesture was generated during the second touch. To do this, the relevant process (i.e. the bookmark gesture recognition part 135 or 635 or the confirmation recognition part 636) determines whether all of the points along the stroke were within the fold area and determines whether the length of the stroke was longer than the preset threshold length. If both are found to be true then the processor (130 or 630 respectively) determines that a touch stroke (or stroke gesture) has been received.

That is, using d(k) of equation 1 and LPT of equation 2, the processes make their respective determinations as follows:

### Conditional Statement 5—Stroke Test

IF d(k)<A (k=0, 1, 2, . . . , N) AND LPT>D,
   THEN TOUCH_STROKE (or STROKE_GESTURE) is generated.

In an alternative embodiment, in a simpler version of the above Stroke Test, the shortest distance between the start (initial) point and the end point is used instead of LPT. That is, instead of determining whether LPT is greater than the threshold distance (D), it is determined whether the distance between the first point and last point of a stroke is greater than a threshold distance.

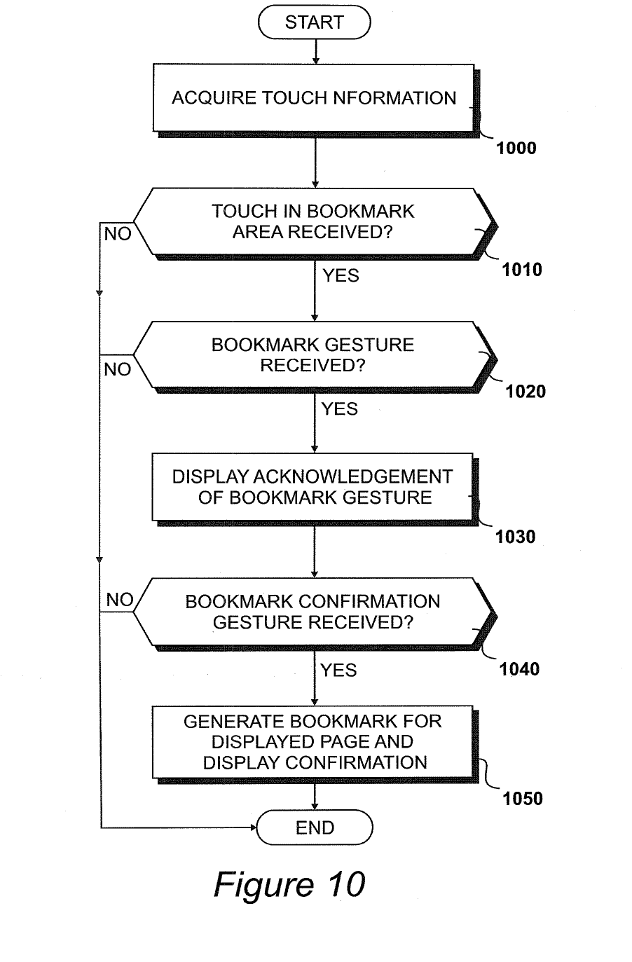

### FIG. 10

A flow chart of a bookmark set up method embodying the present invention is shown in FIG. 10.

The touch of a user on the touch screen generates touch signals and at step 1000 the touch acquisition unit of the processor gets the location information of a plurality of touch points in the touch. Although this is shown as a single step, it should be understood that the processor (130 or 630) continues to obtain current touch information from the touch screen during the subsequent process steps.

At step 1010 it is determined whether or not acquired touch information represents a touch in the bookmark area, and, if not, the process goes to END. If the touch information is found to be in the bookmark area at step 1010, then step 1020 is performed.

At step 1020, the bookmark gesture recognition part of the processor processes the location information that is being received to determine whether a bookmark gesture is recognised. If it is determined at step 1030 that a bookmark gesture is not being received, then the process goes to END.

If a bookmark gesture is recognised at step 1020, it is acknowledged at step 1030 by displaying a graphic in the currently displayed page to indicate that the bookmark gesture has been received. In one embodiment, as described above, the displayed graphic is the folded corner in the currently displayed page. In an alternative embodiment this takes the form of another visual acknowledgement, for example a confirmation window, such as that shown in FIG. 5.

When the step 1030 is completed, the gesture decision unit of the processor then determines, at step 1040, based upon the currently received touch information, whether a bookmark confirmation gesture is received, confirming that a bookmark should be generated. If a bookmark confirmation gesture is not received, the process goes to END.

When a bookmark confirmation gesture is received at step 1040, a bookmark is generated for the currently displayed page and confirmed on the display unit at step 1050.

In a further alternative embodiment, such as described above in respect of FIG. 1, no confirmation of the bookmark gesture is required, and steps 1030 and 1040 are effectively eliminated from the process.

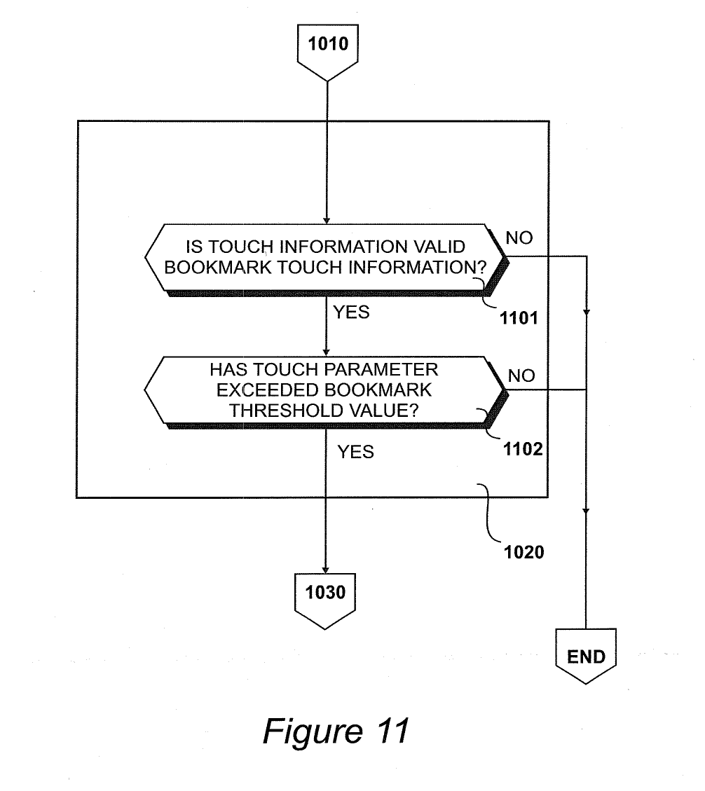

### FIG. 11

The recognition process of the bookmark gesture of step 1020 of FIG. 10 comprises the multiple steps illustrated in the flow chart of FIG. 11.

Initially in step 1020, the step 1101 determines whether the current touch information corresponds to a valid bookmark touch. In the present embodiment this takes the form of determining whether the touch information corresponds to a touch located inside the bookmark area. In an alternative embodiment, the e-book reader has a touch screen that also provides an output signal providing a measurement of pressure applied during the touch. Thus, in such embodiments, the step 1101 takes the form of determining both whether the touch information corresponds to a touch within the bookmark area and whether the touch measurement is above a preset pressure threshold.

If touch information corresponds to a valid bookmark touch, then the process enters step 1102 where it is determined whether a touch parameter has exceeded a bookmark threshold value. In the present embodiment this step takes the form of determining whether the touch information corresponded to a drag over the preset threshold length. In alternative embodiments, this step takes the form of determining whether the touch is held for more than a threshold period. In some alternative embodiments, more than one parameter is used. For example, the process may determine if the touch information corresponds to a drag over the preset threshold length and for more than a threshold period of time.

If it is determined at step 1102 that the touch parameter has been exceeded then the process determines that a bookmark gesture has been received and it enters step 1030, where the bookmark gesture is acknowledged. Alternatively, if it is found that the threshold value has not been exceeded at step 1102, then the process goes to END.

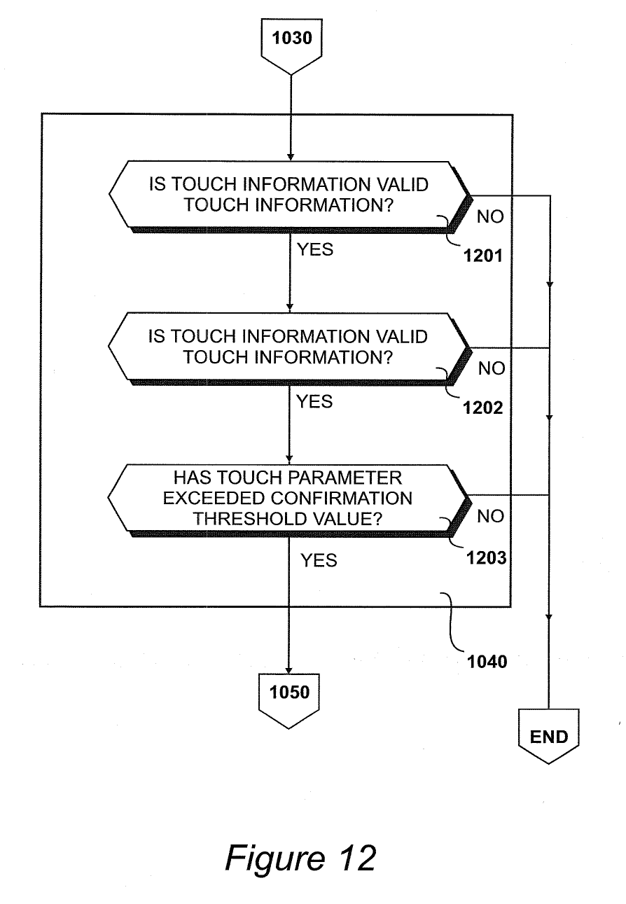

### FIG. 12

The recognition process for the bookmark confirmation gesture at step 1040 of FIG. 10 comprises the multiple steps illustrated in the flow chart of FIG. 12.

Initially at step 1201 it is determined whether the current touch information is valid for a bookmark confirmation gesture. In the present embodiment this takes the form of determining whether the touch information corresponds to a touch located inside the bookmark confirmation area. The bookmark confirmation area in the present embodiment is the fold area, as described with reference to FIG. 9, but in alternative embodiments it is the bookmark area or the area corresponding to the “OK” button on the confirmation window of FIG. 5. In alternative embodiments, in which the e-book reader also has a touch screen that provides a measurement of pressure applied during the touch, the step 1201 takes the form of determining both whether the touch information corresponds to a touch within the confirmation area and whether the touch measurement is above a preset pressure threshold.

If it is determined at step 1201 that the touch information is not valid for a bookmark confirmation gesture, the process goes to END.

If it is determined at step 1201 that the touch information is valid for a bookmark confirmation gesture, the process enters step 1202 where the same question as step 1201 is asked again. However, this time, if the question is answered negatively, indicating that the gesture does not meet the requirements for a bookmark confirmation gesture, the process goes to END and a bookmark is not generated. If the question at step 1202 is answered in the positive, the process enters step 1203 where it is determined whether a touch parameter has exceeded a confirmation threshold value.

In the present embodiment step 1203 takes the form of determining whether the touch information corresponds to a stroke within the fold area (as described with respect to FIG. 9) over the preset threshold length. In alternative embodiments, this step takes the form of determining whether the touch is held for more than a threshold period, or whether the touch has a reference count more than a predefined number. In some alternative embodiments, more than one parameter is used. For example, the process determines if the touch information corresponds to a drag over the preset threshold length and for more than a threshold period of time.

If it is determined at step 1203 that the touch parameter has been exceeded then the process determines that a bookmark confirmation gesture has been received and it enters step 1050, where the bookmark is generated and the bookmark generation is acknowledged on the screen to the user. If it is found that the threshold value has not been exceeded at step 1203 then the process goes to END.

Alternatively, if it is determined at step 1202 that the touch is not a valid touch then the process goes to END.

Although the above description has focussed upon the creation of a bookmark for a displayed page, it is also envisaged that a bookmark for a displayed page be released (i.e. removed) by similar gestures to those described for the creation of the bookmark. For example, in an embodiment, when a displayed page has a bookmark, this bookmark is cancelled by providing a drag within the bookmark area over a distance that is greater than a threshold length. In alternative embodiments, the bookmark is cancelled by a valid touch in the form of a stroke gesture in the fold area, and constant pressure within the valid touch is more than the reference count, or a touch and hold in the bookmark area, etc.

Although the above description and in particular FIGS. 1 and 6 refer to a single processor, it will be understood that the invention may incorporate more than one processor working in parallel. For example, at least some of the operations performed relating to acquiring position information from the touch input device may be performed on a separate controller, in communication with the main processor. Thus, reference herein to a processor should be understood to mean at least one processor.

What we claim is:

1. Apparatus for displaying an electronic book comprising:
a touch screen configured to display a selected page of textual information of an electronic book, said touch screen having a touch input device configured to generate signals in response to a touch input on said touch screen; and
a processor comprising:
a touch acquisition module configured to obtain touch position information of a touch input from said touch input device;
a gesture recognition module configured to determine if a touch input is a bookmark gesture in dependence of whether said touch position information is within a bookmark area or not within said bookmark area; and
a bookmark processing module configured to generate a bookmark for the selected page when a bookmark gesture is recognized by said gesture recognition module.

2. The apparatus of claim 1, in which said apparatus has an initialisation part configured to initialise said bookmark area in at least one of the corners or edges of the selected page.

3. The apparatus of claim 1, in which the gesture recognition module comprises:
a valid touch recognition module configured to receive a series of touch position information generated during a touch on said touch screen and to recognize valid touches within the bookmark area or a fold area of the bookmark area based said series of touch position information; and
a gesture decision module configured to determine if a touch input is a bookmark gesture in dependence of one of the following group: (a) a reference count of a touch within the bookmark area exceeds a preset threshold number; (b) a touch is held for more than a preset threshold time; and (c) a length of a touch drag exceeds a preset threshold length.

4. The apparatus according to claim 1, further comprising a confirmation recognition part configured to recognize a bookmark confirmation gesture of a user in dependence upon touch position information corresponding to a touch within a confirmation area of the touch screen,
said bookmark processing module being configured to generate a bookmark only when said gesture recognition module recognizes a bookmark gesture and said confirmation recognition part recognizes a bookmark confirmation gesture.

5. The apparatus according to claim 4, wherein said confirmation recognition part is configured to receive a contiguous series of position information of touch points generated during a touch on said touch screen and to determine whether a bookmark confirmation gesture is received in dependence upon said contiguous series of position information of touch points.

6. The apparatus according to claim 4 wherein said touch input device is configured to provide signals that include pressure information of said touch input, and said apparatus further comprises a pressure acquisition module configured to obtain a pressure value for a touch applied to the touch input device, wherein said gesture recognition module determines that a touch input is a bookmark gesture only when said touch input generates a pressure value greater than a preset pressure value.

7. The apparatus according to claim 4, wherein said touch input device is a multi-touch input device, and the gesture recognition module is configured to determine whether a bookmark gesture is received in dependence of touch position information of two simultaneous touches.

8. The apparatus according to claim 4, wherein said apparatus is configured to display a graphic providing an acknowledgement of a received bookmark gesture when said gesture recognition module determines that a bookmark gesture has been received for a displayed page, and said graphic is configured to provide an indication of the location of said confirmation area.

9. The apparatus according to claim 8, wherein said graphic is a line and said confirmation area extends along said line and to each side of said line.

10. The apparatus according to claim 4, wherein said confirmation area is within said bookmark area.

11. The apparatus according to claim 1, wherein said bookmark area comprises an area adjacent to a corner of said touch screen.

12. The apparatus according to claim 1, wherein said bookmark gesture comprises stroking said touch screen within said area adjacent to said corner.

13. A bookmark set-up method for an electronic book comprising:
displaying a page of textual information on a touch screen;
receiving a touch input on said touch screen;
generating touch position information in response to receiving said touch input;
analyzing said touch position information to determine whether said touch input is a bookmark gesture or not a bookmark gesture, and
when it is determined that said touch input is a bookmark gesture, acknowledging on said touch screen the receipt of said bookmark gesture.

14. The bookmark set-up method of claim 13 in which said method comprises the further step of defining at least one edge portion of the displayed page, or at least one corner of the displayed page, as the bookmark area.

15. The bookmark set-up method of claim 13 in which the step of analyzing said touch position information comprises analysing a series of items of touch position information of a touch within the bookmark area and determining if a touch input is a bookmark gesture in dependence of one of the following group: (a) a reference count of a touch within the bookmark area exceeds a preset threshold number; (b) a touch is held for more than a preset threshold time; and (c) a length of a touch drag exceeds a preset threshold length.

16. The bookmark set-up method of claim 13 in which, when it is determined that a touch input is a bookmark gesture, further comprising the step of analyzing further touch position information generated from a further touch on said touch screen to determine if said further touch is a bookmark confirmation gesture.

17. The bookmark set-up method of claim 16 in which said step of analysing further touch position information comprises receiving a series of touch position information items over a period of time, and determining that said further touch is a bookmark confirmation gesture only when said period of time exceeds a threshold period.

18. The bookmark set-up method of claim 16 further comprising the steps of generating a pressure value having a magnitude that depends on a pressure of the touch input, and determining that said further touch is a bookmark confirmation gesture only when said pressure value exceeds a threshold pressure value.

19. The bookmark set-up method of claim 16 in which said touch screen is a multi touch screen, said touch input comprises two touches applied to two different parts of said touch screen, and said touch position information comprises information of each of said two touches.

20. A non-transitory computer-readable medium encoded with program instructions executable by a computer that, when executed by the computer, cause the computer to perform a method of:
displaying a page of textual information on a touch screen;
receiving a touch input on said touch screen;
generating touch position information in response to said touch input;
analyzing said touch position information to determine whether said touch input is a bookmark gesture or not a bookmark gesture, and
when it is determined that said touch input is a bookmark gesture, acknowledging on said touch screen the receipt of said bookmark gesture.
